(19) United States
(12) Patent Application Publication
(10) Pub. No.: US 2015/0185728 A1
(43) Pub. Date: Jul. 2, 2015

(54) METHODS AND APPROACHES FOR FABRICATING LOW-COST ROTATING BIOLOGICAL AQUARIUM WATER FILTER SYSTEMS

(71) Applicant: Sustainable Aquatics, Inc., Jefferson City, TN (US)

(72) Inventors: John J. Carberry, Talbott, TN (US); Matthew John Carberry, Talbott, TN (US)

(21) Appl. No.: 14/580,408

(22) Filed: Dec. 23, 2014

Related U.S. Application Data
(60) Provisional application No. 61/921,013, filed on Dec. 26, 2013.

(51) Int. Cl. G05B 19/414; B23Q 15/20; A01K 63/04

(52) U.S. Cl. CPC G05B 19/4145; A01K 63/045; B23Q 15/20

(57) ABSTRACT

Methods and processes for manufacturing components for a biological aquarium water filter system include using DXF files through CAD/CAM technology to quickly and inexpensively machine planer parts components for a biological aquarium water filter system, said DXF files including X-dimension and Y-dimension geometries and geometries selected from the group consisting of slots, holes, and countersunk holes.

### CROSS-REFERENCE TO RELATED APPLICATIONS

This Application claims the benefit of U.S. Provisional Patent Application No. 61/921,013, filed Dec. 26, 2013, the entire contents of which are incorporated herein by reference.

### STATEMENT REGARDING FEDERALLY SPONSORED RESEARCH OR DEVELOPMENT

Not Applicable

### BACKGROUND OF THE INVENTION

1. Field of Invention

The present general inventive concept relates to the preparation and use of components for biological aquarium water filter systems.

2. Description of the Related Art

U.S. Pat. No. 5,419,831, issued to Fuerst et al., discloses an aquarium filter system having a rotatably mounted filter body. The filter body is structured such that when mounted with a portion of the filter body submerged in moving water, rotational movement is imparted to the filter body by the moving water. As a result of the rotational movement, at least a portion of the filter body is alternately exposed to the water and the atmosphere. This fosters the growth of aerobic bacteria on the surface of the filter body. The aerobic bacteria reduces the level of toxins within the aquarium water.

U.S. Pat. No. 5,779,885, issued to Hickok et al, discloses an aquatic filter system having a rotatably mounted cylindrical filter body. The cylindrical filter body is formed by a water absorbing mass of material. Water applied to one side of the filter body unbalances the filter body which causes the filter body to rotate. As a result of the rotational movement, at least a portion of the filter body is alternately exposed to the water and the atmosphere to foster the growth of aerobic bacteria on the surfaces of the filter body.

U.S. Pat. No. 5,419,831, issued 30 May 1995, and its relative U.S. Pat. No. 5,779,885, issued 14 Jul. 1998, teach the construction of an aquarium filter system having a rotating mounted cylinder composed of a reticulated porous medium in which aerobic bacteria can grow in large populations and process NH3 into NO2 and then into NO3, a necessary process for the keeping of healthy fish in a closed-system aquarium or aquatic environment. Of the three, NO3 is relatively non-toxic to the animals and is a nutrient for plants and algae. NH3 and NO2 are very toxic to fish, especially marine ornamental fish.

While this patent was issued on 30 May 1995 and its application predates the change in the patent term law enacted in June 1995, when the term of non-design patents was changed from 17 years to 20 years, it has thus expired on May 30, 2012. However we found an exceptionally large barrier to making this system even using the teachings in these patents due to the very high cost of tooling the components as described, anticipated, and as subsequently manufactured and sold by the eventual owner, United Pet Group's Marineland Division. This patent does not teach or solve the problem of making the subcomponents without incurring very high tooling costs, without very long lead times and without exceptionally limited design freedoms, and instead relies on classic injection-molded tooling which is very expensive, uses excess space (thus limiting the amount of poly fiber), and limits design freedoms.

### BRIEF SUMMARY OF THE INVENTION

Disclosed herein are methods and processes to fabricate components for a biological aquarium water filter system include using DXF files through CAD/CAM technology to quickly and inexpensively machine planer parts components for a biological aquarium water filter system, said DXF files including X-dimension and Y-dimension geometries and geometries selected from the group consisting of slots, holes, and countersunk holes.

In at least one example embodiment of the present general inventive, a process for fabricating components for a biological aquarium water filter system includes using DXF files through CAD/CAM technology to quickly and inexpensively machine planer parts components for a biological aquarium water filter system, said DXF files including X-dimension and Y-dimension geometries and geometries selected from the group consisting of slots, holes, and countersunk holes, said components facilitating self-jigging for ease of assembly.

In some embodiments, said components include planer parts, shafts, seals, bearings, and discs.

In some embodiments, said discs include planer polyfiber discs.

In some embodiments, said components include a housing and a tray adapted to fit onto the top of said housing, said tray including a plurality of holes into which are fit tubes, said tubes allowing the passage of water into said housing.

In some embodiments, said components include a first tray adapted to fit onto the top of said housing and a second tray adapted to fit onto the top of said first tray.

In an example embodiment of the present general inventive concept, a method for manufacturing components for a biological aquarium water filter system encompasses using DXF files through CAD/CAM technology to quickly and inexpensively machine planer parts components for a biological aquarium water filter system, said DXF files including X-dimension and Y-dimension geometries and geometries selected from the group consisting of slots, holes, and countersunk holes.

In some embodiments, said components include planer parts, shafts, seals, bearings, and discs.

In some embodiments, said discs include planer polyfiber discs.

In some embodiments, said components include a housing and a tray adapted to fit onto the top of said housing, said tray including a plurality of holes into which are fit tubes, said tubes allowing the passage of water into said housing.

In some embodiments, said components include a first tray adapted to fit onto the top of said housing and a second tray adapted to fit onto the top of said first tray.

In some embodiments, wherein the bottom of the housing includes at least three counter-cut holes on the bottom surface such that lengths of PVC pipe can be cut to control the height of the biological aquarium water filter system within water.

### BRIEF DESCRIPTION OF THE SEVERAL VIEWS OF THE DRAWINGS

The above-mentioned features and other aspects of the invention will become more clearly understood from the following detailed description of the invention read together with the drawings in which:

FIG. 1 is a perspective view of an example embodiment of an aquarium water filter system with components fabricated according to methods and processes as disclosed herein;

FIG. 2 is an exploded view the example embodiment shown in FIG. 1;

FIG. 3 is a perspective view of the biological wheel filter element used in the example embodiment aquarium water filter system shown in FIG. 1; and

FIG. 4 is a sectional view of the filter wheel as positioned and used in the example embodiment shown in FIG. 1.

### DETAILED DESCRIPTION OF THE INVENTION

Disclosed herein are methods and processes to fabricate component parts for a biological aquarium water filter system. DXF files are used through CAD/CAM technology to quickly and inexpensively machine planer parts components for a biological aquarium water filter system, said DXF files including X-dimension and Y-dimension geometries and geometries selected from the group consisting of slots, holes, and countersunk holes.

In tests in fish systems, where very large numbers of fish are kept and grown in each system, it has been found that a according to the design generally described in U.S. Pat. No. 5,779,885 was exceptionally effective at performing to its claims of being able to nurture and grow very large quantities of aerobic bacteria, thus dramatically reducing the amounts of NH₃ and NO₂ in the water. Aerobic bacteria cultures for processing NO₃ through NO₂ into NO₃ is much preferred to anaerobic bacteria for many reasons, but a key one is that while there are 210,000 ppm O₂ in the air we breathe, there is only 8 ppm O₂ in water. Having a large culture of anaerobic bacteria competing with the fish in the system for this oxygen can be very limiting to the keeping of larger numbers of healthy fish. Having a large culture of aerobic bacteria processing the NH₃ and NO₂ using air from the atmosphere and at the same time scrubbing CO₂ from the water and adding oxygen is very accretive to holding large numbers of very healthy fish.

This strong filtering performance reduces the amount and frequency of water changes we have to make, reduces labor costs, reduces salt costs in the case of the non-fresh-water marine systems, reduces NH₃ and NO₂, increases oxygen content and availability, and increases fish health and fish growth as well. But we also found that the system was exceptionally efficiency at scrubbing CO₂ from the water and oxygenating the water as well.

Fluidized bed reactors can be very effective at accomplishing this same end but are much harder to maintain, require high skill levels, and suffer from the fact that losing power in water flow through the medium, normally sand, results in rapid death of the bacteria culture in as few as several minutes, which can result in an exceptionally toxic byproduct deadly to fish and other animals. This is a common occurrence and concern with fluidized bed reactors that this approach avoids entirely.

In attempting to purchase large numbers of these assemblies from Marineland, we found that the unit-cost, even in volumes of hundreds of units, was exceptionally and prohibitively high. Also, Marineland's commercial interest seems to be focused to channel the sale of their bio wheel assemblies tied to their sales of systems such as large commercial retail fish-holding systems. This may be because of the high stand-alone cost of the bio-wheel so manufactured. We inferred that the price was very high also because of the high cost of the molded parts, the amortization of the tooling for the molded parts, and the high associated cost of the assembly thus manufactured.

While Marineland has been very successful to place these bio-wheel products in the systems they sell to very large retail chains, the smaller independent retailers who seldom buy turn-key systems such as the large box retailers buy have not had available to them an economical bio wheel as described and taught by these patents, even though such a product has proven to be of great value. And they have not had available the many sizes and scales they require for the very varied systems sizes and configurations. In our efforts, we were not able to buy the product in the many configurations we need at an economical cost. We identify a strong unfulfilled need for an economical product with great design freedom so to be able to customize size and scale and design for the many various applications in the market.

Our invention teaches an approach where expensive and hard tooling is not required for manufacturing the assembly of both the wheel and the system holding the wheel, thus enabling economical design freedoms providing higher poly foam density and greater filtration for a wide variety of applications.

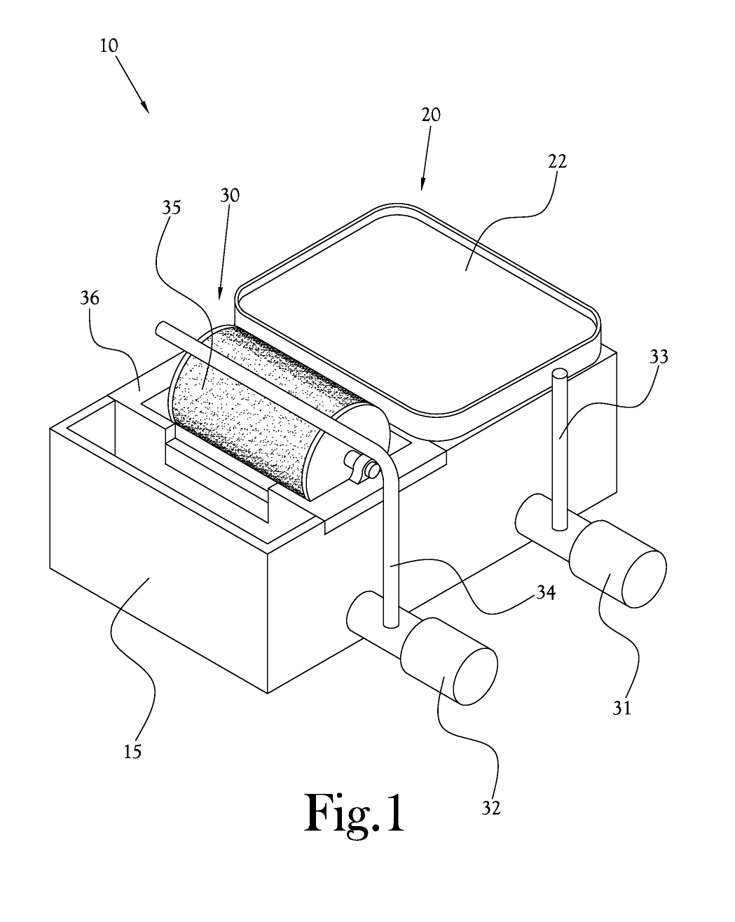

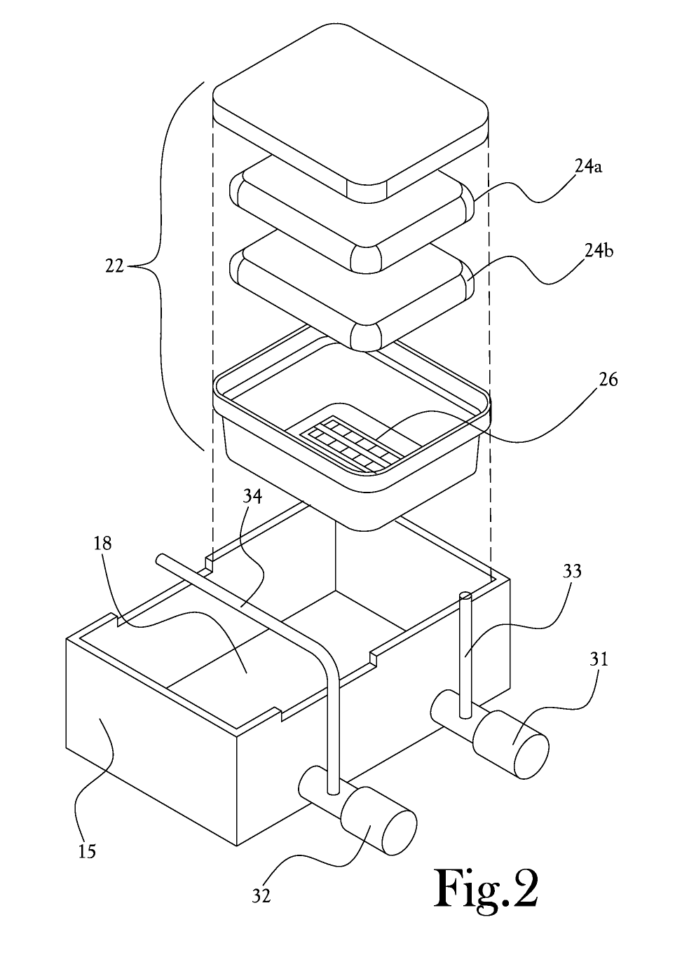

Turning to the Figures, FIG. 1 shows a perspective view of an aquarium water filter system 10. As shown in FIG. 1 and in the exploded view of FIG. 2, the illustrated example embodiment aquarium water filter system 10 includes a housing 15 that encompasses a pad-based filtration assembly 20 and a biological wheel filtering assembly 30. Generally, water is drawn from an aquarium or similar reservoir by a pump or other means. In some embodiments, water flows into the housing through the pad-based assembly 20, and then is pumped to the biological wheel filtering assembly 30. The pad-based assembly 20 includes a filter box 22, which itself houses a number of filter pads 24a, 24b including activated carbon. (In some embodiments, filter pads 24 are provided in the filter box together with one or more of a variety of filtering chemicals such as a layer of activated carbon.) In the illustrated example embodiment, the filter box 22 is provided with a plurality of openings 26 adjacent the bottom of the box to allow water filtered through the filter pads to flow out of the filter box 22 into a sump 18 of the housing 15. Thus, water entering the sump 18 from the filter box 22 is mechanically and chemically filtered.

A first pump 31 draws filtered water out of the sump 18 and conveys the filtered water through a return tube 33 to the aquarium tank (not shown). A second pump 32 draws filtered water out of the sump 18 and pumps the filtered water into a spray tube 34 that is positioned over the biological wheel filter element 35, which is part of the biological wheel filtering assembly 30, as seen in FIG. 1. The flow rate from the spray tube is controlled by means of a valve or by controlling the speed of the pump 32.

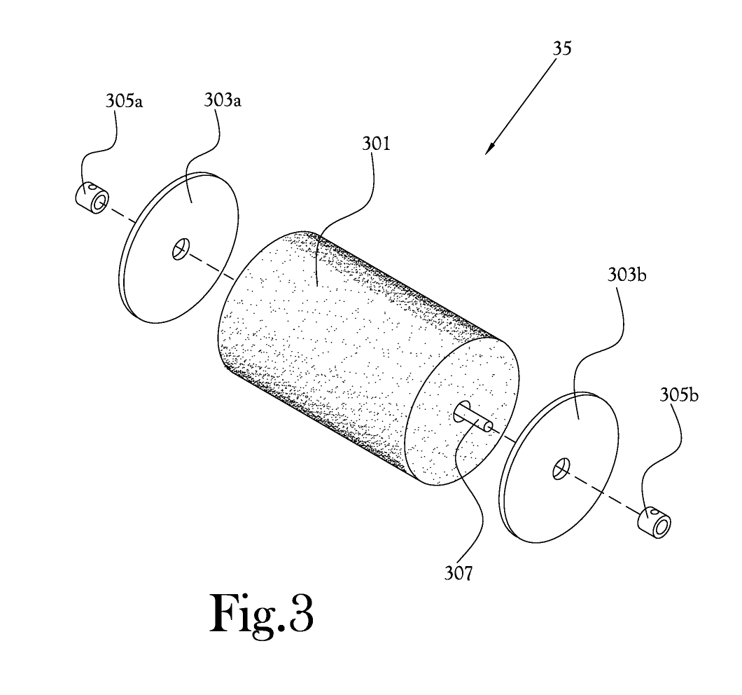

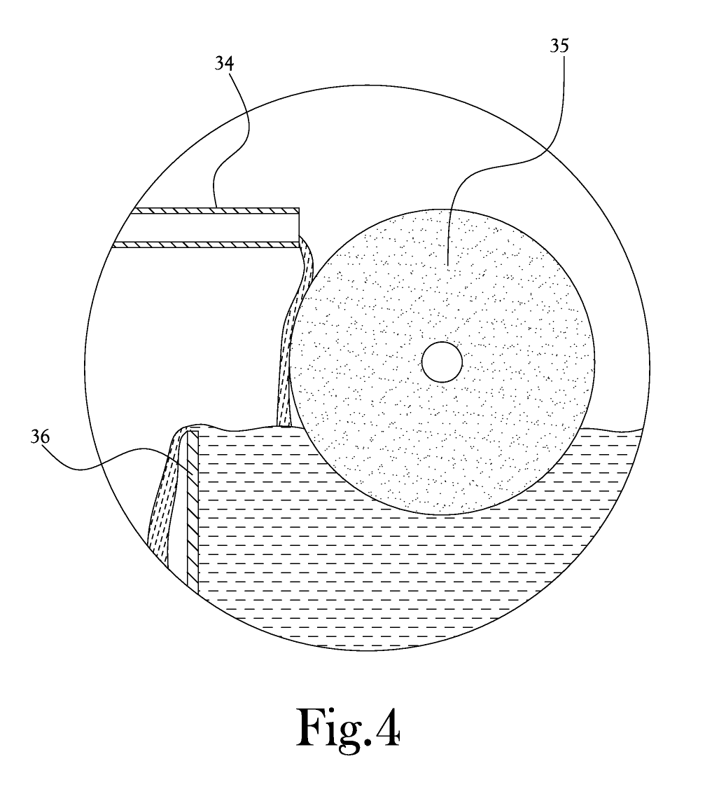

As shown in FIG. 1, the biological wheel filtering assembly 30 includes biological wheel filter element 35 and a biological wheel filter tray 36, within which the biological wheel filter element 35 is rotatably mounted. As shown in FIG. 3 and in the sectional view of FIG. 4, the biological wheel filter element 35 includes a one-piece cylinder 301 generally constituting a porous mass of material. The cylinder 301 is provided with an aperture for receiving a central shaft or axle 307. End plates 303a, 303b are mounted on the central axle 307 by hubs 305a, 305b secured in place by screws or similar devices and means.

As noted above, the high cost of the molded parts, the amortization of the tooling for the molded parts, and the high associated cost of the assembly thus manufactured, combined, contribute to a high cost for an aquarium water filter system along the lines of that illustrated in FIGS. 1-4. In the present general inventive concept, sub-assemblies are designed and fabricated from planer parts; these parts are designed and transferred to computer-aided design and computer-aided manufacturing (CAD/CAM) through the use of DXF files which are easily transferable through this interface. We can use planer materials of various types, for instance expanded poly vinyl chloride (PVC) is preferred. These can obtained in a variety of colors and thicknesses, can be easily machined by programmable machines, for instance CNC, CNC Routers, water jets, and others and then easily assembled and bonded, optimally with self jigging geometries designed into the Z axis of these planer parts. There are several sub-assemblies that can thus be optimally designed and assembled from these planer parts, which are optimally machined using computer numeric controlled (CNC) routing and other automated programmable equipment and assembled using one of the many widely-available PVC cements. Planer stock of various thicknesses can be used, thus allowing various levels of stiffness, as well as the inclusion and insertion by the router bits of various features and functions into the Z axis, as well as the cutting of the parts in the X and Y axis. These Z axis features allow stronger assembly joints as well as self-jigging assembly process and design that further reduces tooling and labor costs.

Advantages to this approach are many. Once a design is fixed and captured in DXF files, these can be used to create a cut pattern to be cut by a CNC router from large planer stock, for instance four by eight feet, of various thicknesses to allow stiffness and features desired. The tooling costs and lead times for tooling are thus completely eliminated. The cost of the assembly is reduced significantly. The cross-section of the structural parts of the elements are dramatically reduced, thus providing space for as many as 30% more discs within a defined volume. There is much greater scope for customizing designs and features for various applications without any additional cost for tooling.

These devices are used in a wide-variety of systems, such as both salt and fresh water aquariums, koi ponds or tanks, which require large capacity for processing nitrogenous wastes, hobbyists tanks, larger fish systems installed and maintained by professionals in public and private spaces, retail store systems, hatchery systems, wholesale and distributor and consolidator systems, public aquariums, and many others. In such a case the scale of systems can range from as little as several to ten gallons, tens to hundreds of gallons to many hundreds to thousands of gallons. Several and any different size assemblies can be constructed by simply scaling part sizes in the DXF files to different sizes by mere key strokes, and then having the DXF files directly program the fabrication by the CNC router. These parts are then assembled in the same way, using geometries cut into the Z axis to assemble the self-jigging parts, without any cost or lead time for tooling. And this can be accomplished quickly and economically regardless of the volumes required for any particular size or scale.

As well the cost and space needed for inventory is dramatically reduced, since the planer cut preassembled parts are much lower cost, especially before assembly, and take up very little inventory space prior to assembly and can be cut by the CNC router upon demand.

The approach of the present general inventive concept generally includes the design of all sub-assemblies from planer parts, which parts are designed and transferred to computer-aided design and computer-aided manufacturing (CAD/CAM) through the use of DXF files which are easily transferable through this interface.

Some embodiments use planer materials of various types, for instance expanded poly vinyl chloride (PVC) is preferred. These can obtained in a variety of colors and thicknesses, can be easily machined by programmable machines, for instance CNC, CNC Routers, water jets, and others and then easily assembled and bonded, optimally with self-jigging geometries designed into the Z axis of these planer parts.

There are several sub-assemblies that can thus be optimally designed and assembled from these planer parts, which are optimally machined using computer numeric controlled (CNC) routing and other automated programmable equipment and assembled using one of the many widely-available PVC cements. Planer stock of various thicknesses can be used, thus allowing various levels of stiffness, as well as the inclusion and insertion by the router bits of various features and functions into the Z axis, as well as the cutting of the parts in the X and Y axis. These Z axis features allow stronger assembly joints as well as self-jigging assembly process and design that further reduces tooling and labor costs. For instance:

Some example embodiments encompass a method for making an assembly for operating a bioprocessing wheel of porous reticulated fibers in which DXF files are used to describe planer subcomponents to be mostly self-jigging for gluing and cementing together into complex assemblies, where the DXF files are used through CAD/CAM technology to quickly and inexpensively machine these planer parts with precise X Y geometries and with geometries such as slots, holes, countersunk holes, which allow self-jigging for ease of assembly using standard PVC Cements and other means of bonding.

Some example embodiments encompass a method as described in the foregoing paragraph wherein the DXF files and CAD/CAM technology allows the easy scaling of the designs so to be able to make the same design in larger or smaller scales as required.

Some example embodiments encompass a method for making a lower assembly into which the bio wheel assembly is mounted, on and in which it rotates, and which holds a pool of water at a controlled depth to fix the depth of the water wheel's lower tangent part through which the wheel rotates. The router made parts conform both to all the X and Y axis planer dimensions, but also end cuts and holes and slots and other features can also be cut into the Z axis to allow jigging of assembly of the parts and other elements; This lower assembly is constructed from nine or more planer components.

Some example embodiments encompass a method for making the wheel assembly which includes two planer parts, shafts, seals, bearings, and several planer polyfiber discs.

Some example embodiments encompass a method and design in which first tray fits onto the top of the lower assembly. It includes a plurality of holes into which are fit tubes so to create a pool of water, optimizing the venturi effect so to be able to move water with efficient non-turbulent flow from this tray onto the wheel in a directed flow and cascade on a tangent angle towards the wheel to cause and control its rotation.

Some example embodiments encompass a method and design in which second tray fits onto the top of the first tray and has slots populating its bottom surface over which a filter pad is placed. In this way solids or particles are filtered out of the water flow before entering the poly fiber in the wheels. These two trays are each constructed from five or more planer parts.

Some example embodiments encompass a method and design in which the bottom of the lower assembly has three or four counter-cut holes on the bottom surface such that lengths of PVC pipe can be cut to control the height of the entire assembly in the water of the sump to assure that the overflow from the bottom of the lower assembly is above the sump water level. The water level in which the wheel rotates is thus controlled by the lower tray/reservoir independent of the mounting height of the assembly.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A process for fabricating components for a biological aquarium water filter system comprising:
using DXF files through CAD/CAM technology to quickly and inexpensively machine planer parts components for a biological aquarium water filter system, said DXF files including X-dimension and Y-dimension geometries and geometries selected from the group consisting of slots, holes, and countersunk holes;
said components facilitating self-jigging for ease of assembly.

2. The process of claim 1 wherein said components include planer parts, shafts, seals, bearings, and discs.

3. The process of claim 2 wherein said discs include planer polyfiber discs.

4. The process of claim 1 wherein said components include a housing and a tray adapted to fit onto the top of said housing, said tray including a plurality of holes into which are fit tubes, said tubes allowing the passage of water into said housing.

5. The process of claim 4 wherein said components include a first tray adapted to fit onto the top of said housing and a second tray adapted to fit onto the top of said first tray.

6. A method for manufacturing components for a biological aquarium water filter system comprising:
using DXF files through CAD/CAM technology to quickly and inexpensively machine planer parts components for a biological aquarium water filter system, said DXF files including X-dimension and Y-dimension geometries and geometries selected from the group consisting of slots, holes, and countersunk holes.

7. The method of claim 6 wherein said components include planer parts, shafts, seals, bearings, and discs.

8. The method of claim 7 wherein said discs include planer polyfiber discs.

9. The method of claim 6 wherein said components include a housing and a tray adapted to fit onto the top of said housing, said tray including a plurality of holes into which are fit tubes, said tubes allowing the passage of water into said housing.

10. The method of claim 9 wherein said components include a first tray adapted to fit onto the top of said housing and a second tray adapted to fit onto the top of said first tray.

11. The method of claim 9 wherein the bottom of the housing includes at least three counter-cut holes on the bottom surface such that lengths of PVC pipe can be cut to control the height of the biological aquarium water filter system within water.
